(19) United States
(12) Patent Application Publication
(10) Pub. No.: US 2016/0107752 A1
(43) Pub. Date: Apr. 21, 2016

(54) Seat Cushion Assembly

(71) Applicant: Skandia, Inc., Davis Junction, IL (US)

(72) Inventor: Gary Palmer, Byron, IL (US)

(73) Assignee: Skandia, Inc., Davis Junction, IL (US)

(21) Appl. No.: 14/919,118

(22) Filed: Oct. 21, 2015

Related U.S. Application Data
(60) Provisional application No. 62/066,538, filed on Oct. 21, 2014.

(51) Int. Cl. B64D 11/06; A47C 7/18

(52) U.S. Cl. CPC B64D 11/0647; A47C 7/18

(57) ABSTRACT

A seat cushion assembly for an aircraft includes a base member with a recess having an upwardly facing lower surface that includes a plurality of spaced apart, elongated continuous first ridges extending upward from the lower surface of the recess and laterally towards its opposite sidewalls. The plurality of first ridges are spaced apart from front to rear relative to the seat cushion assembly to define a plurality of first grooves that extend laterally towards the opposite sidewalls. A central cushion member is positioned within the recess and is configured in a complimentary manner to be received within the recess of the base member. The base member is formed of a resilient foam material that is more rigid than the foam material of which the central cushion member is formed. A laterally extending hole is located in one of the base member or the central cushion member.

### CROSS-REFERENCE TO RELATED APPLICATION

This application claims priority to U.S. Provisional Application Ser. No. 62/066,538, filed Oct. 21, 2014, entitled “Seat Cushion Assembly,” the contents of which are hereby incorporated by reference.

### TECHNICAL FIELD

This disclosure relates generally to a seat cushion assembly and, more particularly, to a seat cushion assembly having a reduced weight and improved performance characteristics.

### BACKGROUND

Seat cushions for seat assemblies are typically designed to be comfortable, durable, and stable for those sitting in the seat. The complexity of the design process may be increased by the desire for the seat assembly to comfortably seat people of a relatively a wide range of sizes. In other words, a seat that is comfortable for a relatively large person may be too firm for a relatively small person. Conversely, a seat that is comfortable for a relatively small person may be too soft for a relatively large person.

As challenging as the design process may be for a typical seat assembly, the design and manufacturing process may be substantially more complicated for seat assemblies used in aircraft. First, the seat assemblies, including their components such as the seat cushions, must meet the applicable standards or regulations from the FAA. In addition, it is generally desirable for the seat assemblies to be as light as possible. Accordingly, a lightweight seat cushion that is comfortable, durable, and stable and fully compliant with FAA regulations is desirable.

### SUMMARY

In one aspect, a seat cushion assembly for an aircraft includes a base member having a front surface, opposite side surfaces, and a recess spaced from the front surface and the side surfaces. The recess has an upwardly facing lower surface including a plurality of elongated first ridges extending upward from the lower surface of the recess with each first ridge extending laterally towards the opposite side surfaces. The plurality of first ridges define a plurality of first grooves that extend laterally towards the opposite side surfaces and the base member is formed of a first resilient foam material. A central cushion member is positioned within the recess and has opposite side edges and a lower surface. The lower surface includes a plurality of elongated second ridges extending downward from the lower surface of the seat cushion member and extending laterally towards the opposite side edges of the central cushion member. The plurality of second ridges define a plurality of second grooves that extend laterally towards the opposite side edges. The first ridges of the base member are positioned within and contacting the second grooves of the central cushion member and the second ridges of the central cushion member are positioned within and contacting the first grooves of the base member. The central cushion member is formed of a second resilient foam material with the first resilient foam material being more rigid than the second foam material. At least one of the base member and the central cushion member have a plurality of laterally extending generally cylindrical openings therein.

In another aspect, a seat cushion assembly for an aircraft includes a base member having a front surface, opposite side surfaces, and a recess spaced from the front surface and the side surfaces. The recess has an upwardly facing lower surface including a plurality of elongated first ridges extending upward from the lower surface of the recess with each first ridge extending laterally towards the opposite side surfaces and having a laterally extending generally cylindrical first opening therein. The plurality of first ridges define a plurality of first grooves that extend laterally towards the opposite side surfaces and the base member is formed of a first resilient foam material. A central cushion member is positioned within the recess and has opposite side edges and a lower surface. The lower surface includes a plurality of elongated second ridges extending downward from the lower surface of the seat cushion member with each second ridge extending laterally toward the opposite side edges of the central cushion member and having a laterally extending generally cylindrical second opening therein. The plurality of second ridges define a plurality of second grooves that extend laterally towards the opposite side edges. The first ridges of the base member are positioned within and contact the second grooves of the central cushion member and the second ridges of the central cushion member are positioned within and contact the first grooves of the base member. The central cushion member is formed of a second resilient foam material with the first resilient foam material being more rigid than the second foam material.

In still another aspect, a seat cushion assembly for an aircraft includes a base member having a front surface, a rear edge opposite the front surface, and a pair of opposite side surfaces. A recess is spaced from the front surface and the side surfaces of the base member with the recess defined at least in part by a front wall, opposite sidewalls, and an upwardly facing lower surface. The upwardly facing lower surface includes a plurality of spaced apart, elongated continuous first ridges extending upward from the lower surface of the recess and laterally towards the opposite sidewalls. The plurality of first ridges are spaced apart from front to rear relative to the seat cushion assembly to define a plurality of first grooves that extend laterally towards the opposite sidewalls and the base member is formed of a first resilient foam material. A central cushion member is positioned within the recess and has a front surface, opposite side edges and a lower surface. The front surface, opposite side edges and the lower surface are configured in a complimentary manner to be received within the recess of the base member. The central cushion member is formed of a second resilient foam material with the first resilient foam material being more rigid than the second foam material. A laterally extending hole is located in one of the first ridges or one of the second ridges.

### BRIEF DESCRIPTION OF THE DRAWINGS

FIG. 1 illustrates a perspective view of seat cushion assembly incorporating the concepts disclosed herein;

FIG. 2 illustrates a second perspective view of the seat cushion assembly of FIG. 1 but from below the seat cushion assembly;

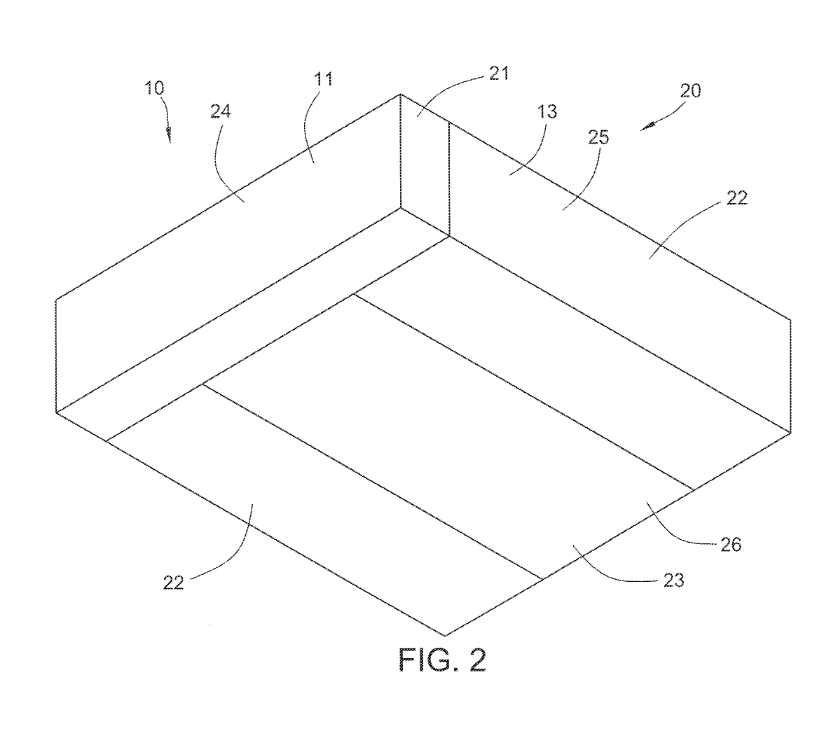

FIG. 3 illustrates a top plan view of the seat cushion assembly of FIG. 1;

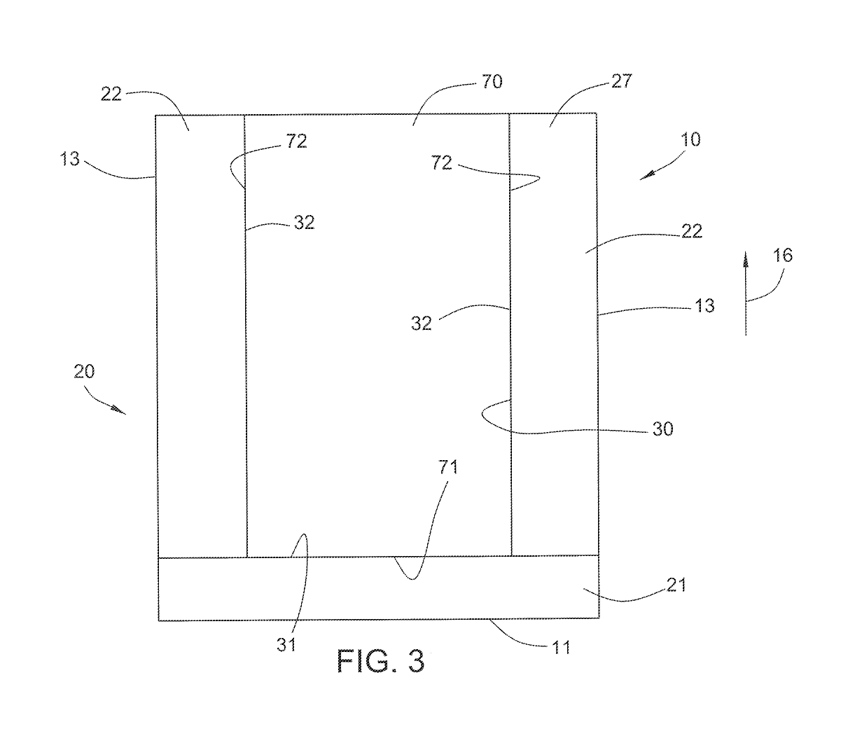

FIG. 4 illustrates a side elevation view of the seat cushion assembly of FIG. 1;

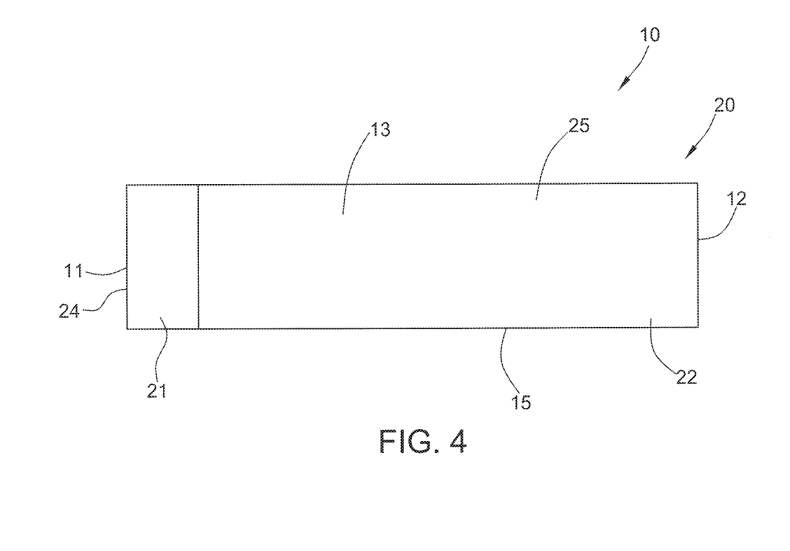

FIG. 5 illustrates a front view of the seat cushion assembly of FIG. 1;

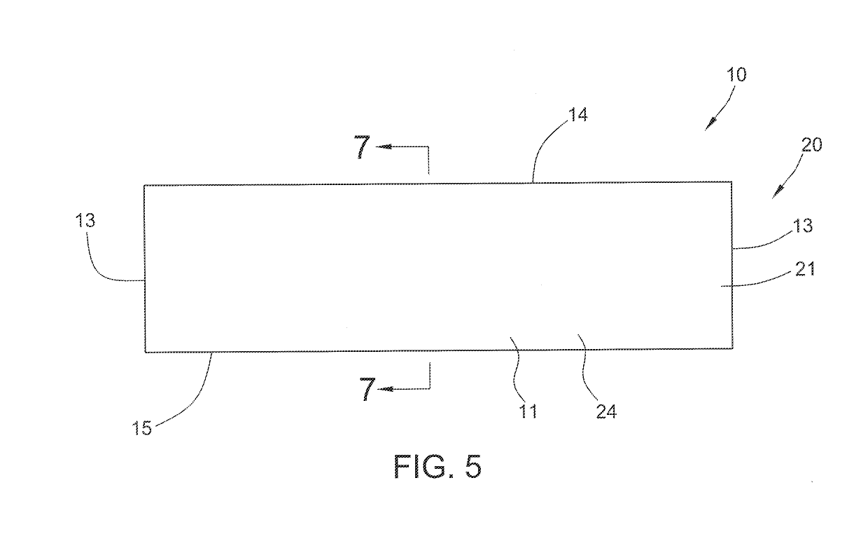

FIG. 6 illustrates a rear view of the seat cushion assembly of FIG. 1;

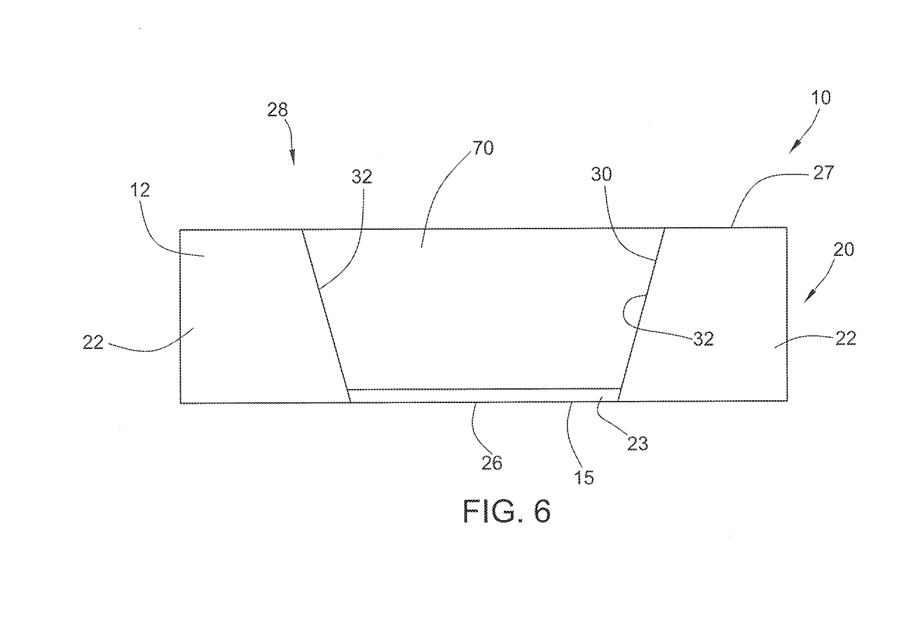

FIG. 7 illustrates a section taken generally along line 7-7 of FIG. 5;

FIG. 8 illustrates a rear view of the base member of the seat cushion assembly of FIG. 1;

FIG. 9 illustrates a section similar to FIG. 7 but only depicting the base member of the seat cushion assembly;

FIG. 10 illustrates a rear view of the central cushion member of the seat cushion assembly of FIG. 1; and

FIG. 11 illustrates a section similar to FIG. 7 but only depicting the central cushion member of the seat cushion assembly.

### DETAILED DESCRIPTION

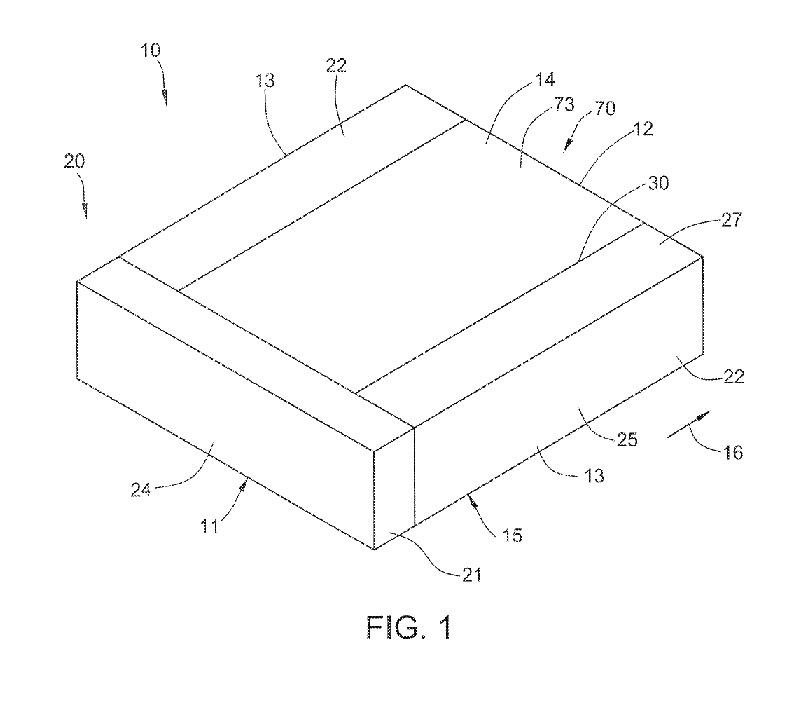

Referring to FIG. 1, a generally rectangular seat cushion assembly 10 is depicted. Seat cushion assembly 10 has a front edge or end 11, and an oppositely facing rear edge or end 12, a pair of oppositely facing sidewall surfaces 13, an upper surface 14, and an oppositely facing lower surface 15. The front end 11 is configured to be positioned near the knees of an occupant and the rear end 12 is configured to be positioned near the back of an occupant and generally adjacent the back rest of a seat (not shown) formed with the seat cushion assembly 10. Each end or surface is depicted as being generally planar and the seat cushion assembly is configured to be trimmed or finished to a desired shape. Once configured in the desired shape, the seat cushion assembly 10 may be covered with a desired dressing or covering material (not shown) such as leather, vinyl, cloth, or any other desired material.

Seat cushion assembly 10 includes a base or base member 20 and a central cushion member 70 that at least partially is positioned within and engages the base.

Base 20 is generally rectangular and may be formed of a plurality of sections or components. More specifically, base 20 may have a front or forward section or component 21, a pair of spaced apart side sections or components 22, and a lower or bottom section or component 23.

Base 20 has a plurality of edges or surfaces that coincide or are coincident with at least a portion of those of the seat cushion assembly 10. More specifically, front section 21 has a front edge or end 24 that coincides or is coincident with the front end 11 of the seat cushion assembly 10. The spaced apart side sections 22 have oppositely facing sidewall surfaces 25 that coincide with sidewall surfaces 13. Lower section 23 has a lower surface 26 that coincides with lower surface 15. The base 20 has a generally U-shaped upper surface 27 that coincides with a portion of the upper surface 14 of the seat cushion assembly 10 and a rear edge or end 28 that coincides with a portion of the rear edge or end 12.

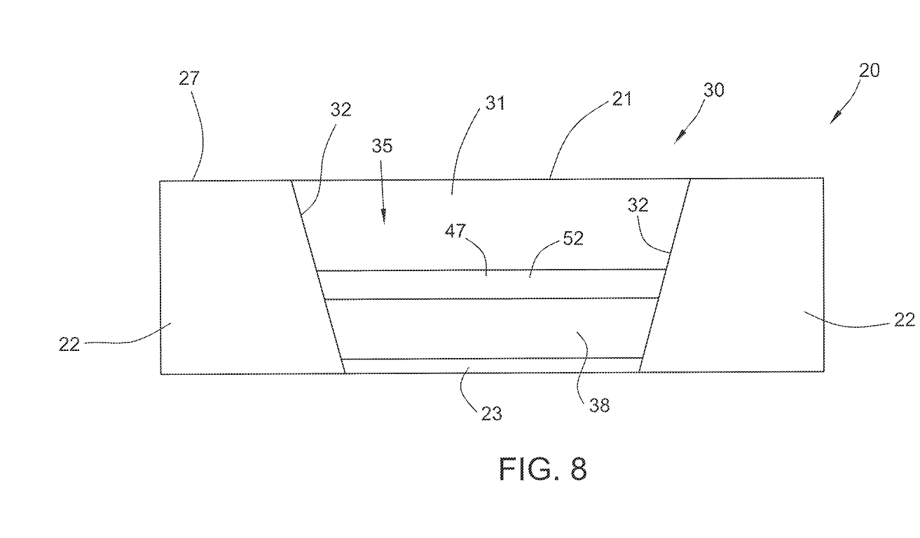

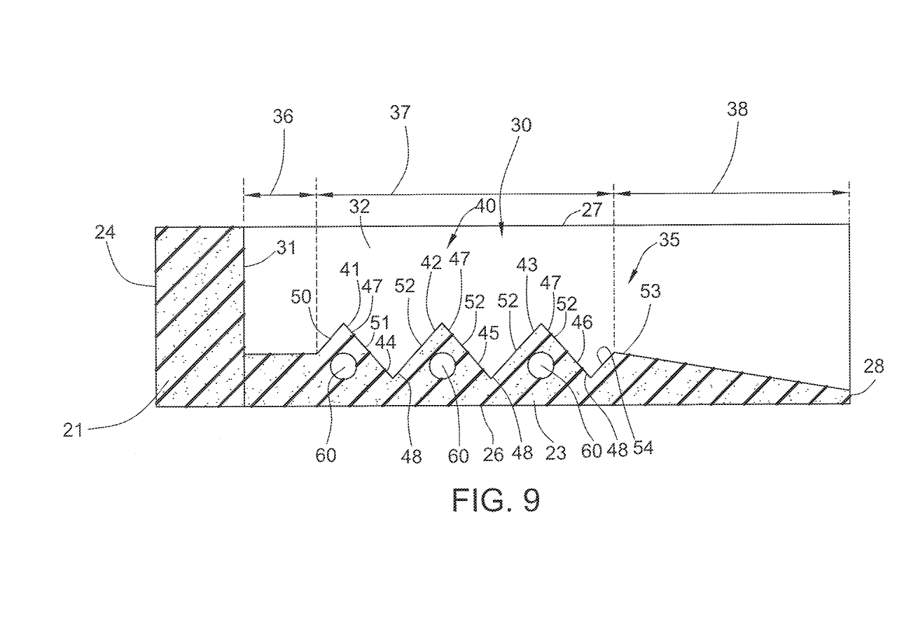

Referring to FIGS. 8-9, a recess or opening 30 extends downward from the upper surface 27 into the base 20 towards the lower surface 26. The front wall 31 of recess 30 is spaced from the front end 24 of base 20 and may be generally vertical or generally parallel to the front end. Opposite sidewalls 32 of the recess 30 are tapered and slope generally inwards towards the lower surface 35 of recess 30. In one embodiment, the sidewalls 32 may slope inward at an angle of no more than approximately 10 degrees. In another embodiment, the sidewalls 32 may slope inward at an angle of between 5 degrees and 15 degrees. In still another example, the sidewalls may be generally vertical. The recess 30 extends from the front wall 21 and intersects with the rear end 28 of the base 20. More specifically, recess 30 is open at the rear end 28 of the base 20.

Upwardly facing lower surface 35 of recess 30 includes a first or forward section 36, a second or middle section 37, and a third or rearward section 38. The forward section 36 may be relatively flat (i.e., generally parallel to the lower surface 26 of base 20) and extends from the front wall 31 of the recess 30 rearward (i.e., from front-to-back as depicted herein by arrow 16) towards the rear end 28 of the base 20.

The middle section 37 has a plurality of laterally extending peaks and valleys configured as sawteeth 40. As depicted, middle section 37 has three triangular ridges 41-43 and three triangular grooves 44-46 that extend laterally between the sidewalls 32 of the recess 30. As best seen in FIG. 9, the ridges 41-43 and grooves 44-46 of middle section 37 are depicted in cross-section as three triangular peaks or projections 47 and three triangular valleys or recesses 48. Each of the projections 47 may extend upward approximately the same distance or height relative to the lower surface 26 of the base 20. However, the ridge 41 closest to the front wall 31 of recess 30 (i.e., the first ridge) begins at the rearward edge of the forward section 36 of lower surface 35 which is above or farther from the lower surface 26 of the base 20. Accordingly, the forward surface or leg 50 of the first ridge 41 is truncated or shorter than the other surface or leg 51 of the first ridge and the surfaces or legs 52 that define the second and third ridges 42, 43.

Each of the recesses 48 extend downward or into the base 20 approximately the same distance. However, the groove 46 closest to the rear end 28 of base 20 (i.e., the third groove) ends or terminates at the forward edge 53 of the rearward section 38 of lower surface 35 which is below or closer to the lower surface 26 of the base 20 than the top of peaks 47. Accordingly, the rearward surface or leg 54 of the third groove 46 is truncated or shorter than the surfaces or legs 52 of the second and third ridges 42, 43 that also define the first and second grooves 44-45.

The angle of the triangular projections 47 and the triangular recesses 48 (i.e., the angles between surface 50 and surface 51, between surface 51 and surface 52, between surfaces 52, and between surface 52 and surface 53) may be set as desired. In one embodiment, acceptable performance has been achieved with the angles at approximately 85 degrees. In other embodiments, the angles be set within a range of 75 degrees to 95 degrees. In still other embodiments, other angles may be used.

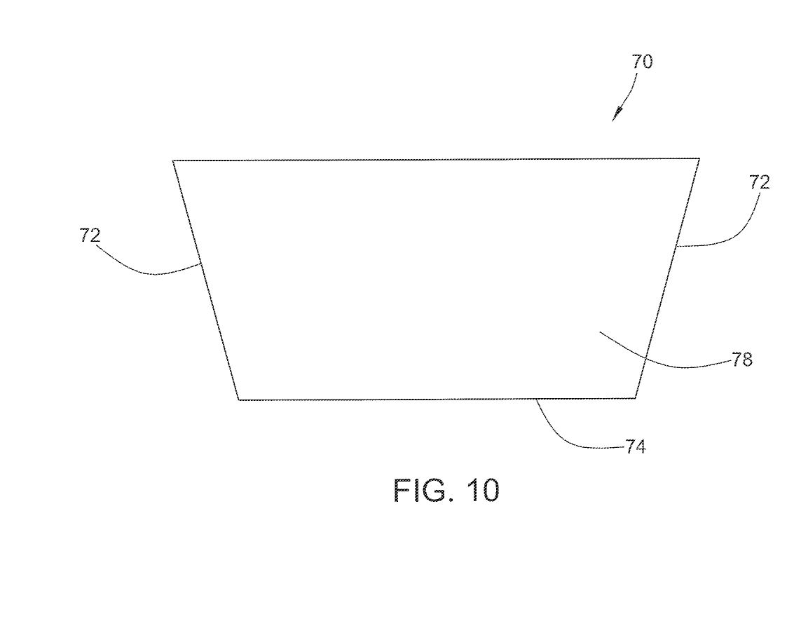

The rearward section 38 of lower surface 35 of recess 30 may slope generally linearly downward and rearwardly towards the lower surface 26 of base 20. As result, the lower section 23 of base 20 decreases or tapers in thickness generally linearly along the rearward section 38 beginning at the middle section 37 and ending at the rear end 28 of the base. In some applications, it may be desirable for the rearward section 38 to slope or taper downward at an angle of no more than approximately 10 degrees. As depicted in FIG. 10, the rearward section 38 slopes at an angle of approximately 9 degrees. While depicted as a linear slope, in some applications, the rearward section 38 may slope in an arcuate manner and in another applications, may be horizontal or have no slope.

In another manner of characterization or description, the rearward leg 54 and the rearward section 38 may be characterized as an additional projection or peak that is shorter than the peaks 47. In such case, the additional projection is defined by the rearward leg 54 and the length of the rearward section 38. The angle of the additional peak may be set as desired. As depicted, the angle is approximately 135 degrees. In other embodiments the angle may range between 125 degrees and 145 degrees. In still other embodiments, any angle may be used.

In one embodiment, the forward section 36 may extend rearward approximately 10-15% of the length of the recess 30. In such embodiment, the middle section 37 may extend along approximately 50-55% of the length of the recess 30, and the rearward section 38 may extend along approximately 30-35% of the length of the recess. Other ratios of the lengths of the sections of the recess 30 are contemplated.

Although depicted with flat surfaces ending in pointed projections 47 and recesses 48, in some applications, the surfaces may be curved or arcuate resulting in curved or arcuate projections and recesses. Still further, in other applications, the surfaces that define the projections and recesses may be flat but the surfaces truncated or shortened so that they do not intersect but rather are connected by a flat or arcuate surface (i.e., the tips of the teeth are cutoff).

The lower section 23 of base 20 includes a plurality of laterally extending openings or holes 60. Each hole 60 is positioned within and extends through one of the triangular ridges 41-43 and may extend through the entire lower section 23 and terminate at side sections 22. All of the holes 60 may be generally horizontally aligned, and each hole may be vertically aligned with its associated peak 47. In some applications, it may be desirable to position the holes 60 at least 1 inch from the lower surface 26 of the lower wall 25.

Each of the holes 60 may have the same diameter. Further, in some applications, it may be desirable for the diameter of each hole 60 to be no larger than approximately 20% of the thickness of the seat cushion assembly 10 after it is trimmed to a desired size. In the embodiment depicted in FIG. 9, the diameter of each hole 60 is approximately 14% of the thickness of the seat cushion assembly 10 (as depicted in its untrimmed condition) and the seat cushion assembly is approximately 7 inches thick.

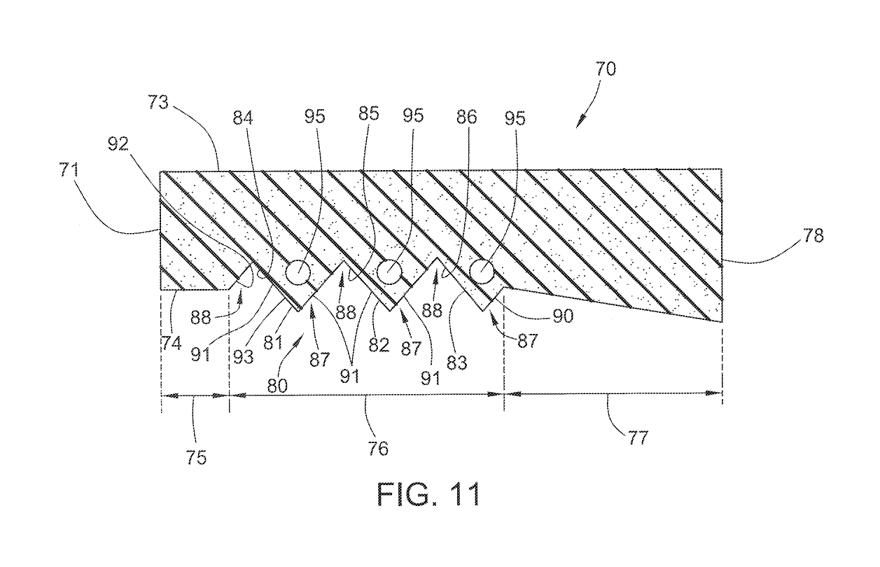

Central cushion member 70 is generally rectangular and configured to have a shape that matches and is received within the recess 30 of base 20. Central cushion member 70 has a forward edge or surface 71 configured to engage and be supported by the front wall 31 of recess 30. Accordingly, the forward surface 71 may be configured to match the angle of the front wall 31 and thus, as depicted in FIG. 11, is generally vertical. A pair of oppositely facing side edges or surfaces 72 (FIG. 10) are configured to engage and be supported by the sidewalls 32 of recess 30. The side surfaces 72 are configured to match the angle of the sidewalls 32 and thus slope at an angle so that the central cushion member 70 is laterally wider at the upper surface 73 relative to the lower surface 74 of the central cushion member.

The lower surface 74 of central cushion member 70 is configured to confront or engage and be supported by the lower surface 35 of recess 30. Accordingly, lower surface 74 has a first or forward section 75, a second or middle section 76, and a third or rearward section 77, with each section shaped or configured with a complimentary shape to its corresponding section of the lower surface 35 of recess 30.

More specifically, the forward section 75 matches the forward section 36 of recess 30 and may be relatively flat and extends from the forward surface 71 rearward towards the rear edge or surface 78 of the central cushion base 70.

The middle section 76 has a plurality of laterally extending peaks and valleys configured as sawteeth 80 that correspond in shape to be opposite the peaks and valleys of middle section 37 of recess 30. As depicted, middle section 76 has three triangular ridges 81-83 and three triangular grooves 84-86 that extend laterally between the side surfaces 72 of the central cushion member 70. As best seen in FIG. 11, the ridges 81-83 and grooves 84-86 of middle section 76 are depicted in cross-section as three triangular peaks or projections 87 and three triangular valleys or recesses 88. Each of the projections 87 may extend downward approximately the same distance or height relative to the upper surface 73 of the central cushion member 70.

However, the projection 87 closest to the rear end 78 of central cushion member 70 (i.e., the third projection from the forward edge 71) ends or terminates at the forward edge of the rearward section 77 of lower surface 74, which is above or closer to the upper surface 73 of the central cushion member 70 than the bottom of peaks 87. Accordingly, the rearward surface or leg 90 of the third ridge 83 is truncated or shorter than the surfaces or legs 91 of the first and second ridges 81, 82.

Each of the recesses 88 extends upward or into the central cushion member 70 approximately the same distance. However, the recess 88 closest to the forward edge 71 of central cushion member 70 (i.e., the first projection) begins at the rearward edge of the forward section 75 of lower surface 74 which is closer to the upper surface 73 of the central cushion member 70 than peak 87. Accordingly, the forward surface or leg 92 of the first groove 84 is truncated or shorter than the other surface or leg 93 of the first groove and the surfaces or legs 91 that define the second and third grooves 85, 86 and also define the first and second ridges 81, 82.

The angles of the triangular projections 87 and the triangular recesses 88 may be configured to match those of triangular projections 47 and the triangular recesses 48 and the description thereof is not repeated herein.

The rearward section 77 of lower surface 74 may slope generally linearly downward and rearwardly away from the upper surface 73 of central cushion member 70. As result, the central cushion member 70 increases in thickness generally linearly along the rearward section 77 beginning at the middle section 76 and ending at the rear surface of the central cushion member. The extent of the slope of the rearward section 77 may match that of the rearward section 38 and the description thereof is not repeated. Based upon the foregoing, it may be understood that the central cushion member 70 is dimensioned to close or fill the recess 30 so that the central cushion member is supported on all sides except along the upper surface 73 and the rear edge 78.

The central cushion member 70 includes a plurality of laterally extending openings or holes 95. Each hole 95 is positioned within and extends through one of the triangular ridges 81-83 and may extend through the entire central cushion member 70. All of the holes 95 may be generally horizontally aligned, and each hole may be vertically aligned with its associated peak 87. In some applications, it may be desirable to position the holes 95 generally within the peaks 87.

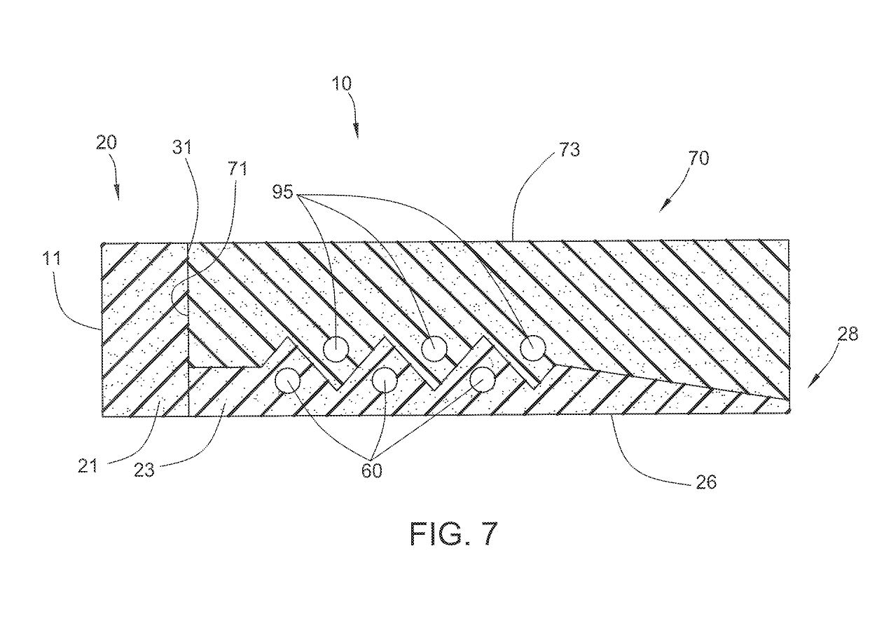

Each of the holes 95 may have the same diameter. If desired, the holes 95 may have the same diameter as holes 60 of base 20. In some applications, it may be desirable for the diameter of each hole 95 to be no larger than approximately 20% of the thickness of the seat cushion assembly 10 after it is trimmed to a desired size. In the embodiment depicted in FIG. 11, the diameter of each hole 95 is approximately 14% of the thickness of the seat cushion assembly 10 (as depicted in its untrimmed condition in FIG. 7) and the seat cushion assembly is approximately 7 inches thick.

Both the base 20 and the central cushion member 70 may be formed of graphite impregnated polyurethane foam. In one embodiment, the base 20 may be formed of a relatively rigid foam material while the central cushion member 70 may be formed of a less rigid or more cushioning foam material. In one example, the base 20 may be formed of DAX 47 ILD foam and the central cushion member 70 may be formed of DAX 26 ILD foam, both of which are distributed by Skandia, Inc. of Davis Junction, Ill.

The base 20 may be assembled by securing the forward section 21, the side sections 22, and the bottom section 23 together using an adhesive such as a water-based adhesive. The central cushion member 70 may also be secured to the base using an adhesive such as a water-based adhesive. The various components may be assembled in any desired order.

The holes 60 in the base 20 and the holes 95 in the central cushion member 70 operate to reduce the overall weight of the seat cushion assembly 10 and to change the cushioning characteristics of the assembly. More specifically, the removal of the material to create the holes 60, 95 increases the amount and rate of compression of both the base 20 and the central cushion member 70. The holes 60, 95 may be formed by removing material from the base 20 and the central cushion member 70 by using a foam saw or in any other desired manner.

The interaction between the peaks and valleys within the middle section 37 of the base 20 and the middle section 76 of the central cushion member 70 provides additional rigidity by controlling the manner in which the base 20 and the central cushion member 70 interact during compression.

By controlling the angle, shape, size, and number of the peaks and valleys within the middle section 37 of the base 20 and the middle section 76 of the central cushion member 70, as well as the position, shape, and size of the holes 60, 90, the comfort of the seat cushion assembly 10 may be increased for a wider variety of occupants. More specifically, the seat cushion assembly 10 may be configured to provide a desirable amount of support for relatively heavy occupants while not feeling too firm for relatively light occupants.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A seat cushion assembly for an aircraft comprising:
a base member having a front surface and opposite side surfaces, the base member having a recess spaced from the front surface and the side surfaces, the recess having an upwardly facing lower surface including a plurality of elongated first ridges extending upward from the lower surface of the recess, each first ridge extending laterally towards the opposite side surfaces, the plurality of first ridges defining a plurality of first grooves that extend laterally towards the opposite side surfaces, the base member being formed of a first resilient foam material;
a central cushion member positioned within the recess, the central cushion member having opposite side edges and a lower surface, the lower surface including a plurality of elongated second ridges extending downward from the lower surface of the seat cushion member, each second ridge extending laterally towards the opposite side edges of the central cushion member, the plurality of second ridges defining a plurality of second grooves that extend laterally towards the opposite side edges, the first ridges of the base member being positioned within and contacting the second grooves of the central cushion member and the second ridges of the central cushion member being positioned within and contacting the first grooves of the base member, the central cushion member being formed of a second resilient foam material, the first resilient foam material being more rigid than the second foam material; and
at least one of the base member and the central cushion member having a plurality of laterally extending generally cylindrical openings therein.

2. The seat cushion assembly of claim 1, wherein the plurality of laterally extending generally cylindrical openings are positioned within at least some of the first ridges or the second ridges.

3. The seat cushion assembly of claim 1, wherein one of the first ridges has one of the laterally extending generally cylindrical first openings therein and one of the second ridges has another of the laterally extending generally cylindrical second openings therein.

4. The seat cushion assembly of claim 3, wherein the seat cushion assembly has a thickness, the first opening has a first diameter, the second opening has a second diameter, and the first and second diameters are no more than 20% of the thickness of the seat cushion assembly.

5. The seat cushion assembly of claim 1, wherein the plurality of elongated first ridges of the base member are spaced from a front wall of the recess and the plurality of elongated second ridges of the central cushion member are spaced from the front surface of the central cushion member.

6. The seat cushion assembly of claim 5, wherein the plurality of elongated first ridges of the base member are spaced from a rear end of the seat cushion assembly and the plurality of elongated second ridges of the central cushion member are spaced from the rear end of the seat cushion assembly.

7. The seat cushion assembly of claim 6, wherein the recess of the base member has a length, a forward section of the recess between the front wall and the plurality of elongated first ridges is approximately 10-15% of the length of the recess, a middle section of the recess including the plurality of elongated first ridges is approximately 50-55% of the length of the recess, and a rearward section of the recess between the plurality of elongated first ridges and the rear end of the seat cushion assembly is approximately 30-35% of the length of the recess.

8. The seat cushion assembly of claim 1, wherein the plurality of elongated first ridges of the base member are spaced from a rear end of the seat cushion assembly and the plurality of elongated second ridges of the central cushion member are spaced from the rear end of the seat cushion assembly.

9. The seat cushion assembly of claim 8, wherein a rearward portion of the upwardly facing lower surface of the base member between the plurality of elongated first ridges of the base member and the rear end of the seat cushion assembly slopes downward from the first ridges towards the rear end.

10. The seat cushion assembly of claim 9, wherein the rearward portion of the upwardly facing lower surface slopes downward at an angle of no more than approximately 10 degrees.

11. The seat cushion assembly of claim 1, wherein the recess of the base member has opposite sidewalls that engage the opposite side edges of the central cushion member.

12. The seat cushion assembly of claim 11, wherein the opposite sidewalls slope inward from an upper surface of the base member towards a lower surface of the base member at an angle of between 5 degrees and 15 degrees.

13. The seat cushion assembly of claim 1, wherein each of the first ridges and each of the second ridges are defined by a pair of legs, and an angle between the legs is between approximately 75 degree and 95 degrees.

14. A seat cushion assembly for an aircraft comprising:
a base member having a front surface and opposite side surfaces, the base member having a recess spaced from the front surface and the side surfaces, the recess having an upwardly facing lower surface including a plurality of elongated first ridges extending upward from the lower surface of the recess, each first ridge extending laterally towards the opposite side surfaces and having a laterally extending generally cylindrical first opening therein, the plurality of first ridges defining a plurality of first grooves that extend laterally towards the opposite side surfaces, the base member being formed of a first resilient foam material;
a central cushion member positioned within the recess, the central cushion member having opposite side edges and a lower surface, the lower surface including a plurality of elongated second ridges extending downward from the lower surface of the seat cushion member, each second ridge extending laterally toward the opposite side edges of the central cushion member and having a laterally extending generally cylindrical second opening therein, the plurality of second ridges defining a plurality of second grooves that extend laterally towards the opposite side edges, the first ridges of the base member being positioned within and contacting the second grooves of the central cushion member and the second ridges of the central cushion member being positioned within and contacting the first grooves of the base member, the central cushion member being formed of a second resilient foam material, the first resilient foam material being more rigid than the second foam material.

15. The seat cushion assembly of claim 14, wherein the seat cushion assembly has a thickness, the first openings have a first diameter, the second openings have a second diameter, and the first and second diameters are no more than 20% of the thickness of the seat cushion assembly.

16. The seat cushion assembly of claim 14, wherein the recess of the base member has opposite sidewalls that slope inward towards a centerline of the base member from an upper surface of the base member towards a lower surface of the base member at an angle of between 5 and 15 degrees and the opposite sidewalls engage the opposite side edges of the central cushion member.

17. A seat cushion assembly for an aircraft comprising:
a base member having a front surface, a rear edge opposite the front surface, and a pair of opposite side surfaces, the base member having a recess spaced from the front surface and the side surfaces, the recess defined at least in part by a front wall, opposite sidewalls, and an upwardly facing lower surface, the upwardly facing lower surface including a plurality of spaced apart, elongated continuous first ridges extending upward from the lower surface of the recess and laterally towards the opposite sidewalls, the plurality of first ridges being spaced apart from front to rear relative to the seat cushion assembly to define a plurality of first grooves that extend laterally towards the opposite sidewalls, the base member being formed of a first resilient foam material;
a central cushion member positioned within the recess, the central cushion member having a front surface, opposite side edges and a lower surface, the front surface, opposite side edges and the lower surface being configured in a complimentary manner to be received within the recess of the base member, the central cushion member being formed of a second resilient foam material, the first resilient foam material being more rigid than the second foam material; and
a laterally extending hole, the laterally extending hole being located in one of the first ridges or one of the second ridges.

18. The seat cushion assembly of claim 17, wherein each of the first ridges has a laterally extending first hole therein.

19. The seat cushion assembly of claim 18, wherein each of the second ridges has a laterally extending second hole therein.

20. The seat cushion assembly of claim 19, wherein the seat cushion assembly has a thickness, the first holes have a first cross-sectional area, the second holes have a second cross-sectional area, and the first and second cross-sectional areas are no more than 20% of the thickness of the seat cushion assembly.
